(19) United States
(12) Patent Application Publication
(10) Pub. No.: US 2007/0236753 A1
(43) Pub. Date: Oct. 11, 2007

(54) Apparatus and method for image processing

(75) Inventor: Koichi Watanabe, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushi Kaisha Toshiba, Minato-ku (JP); Toshiba Tec Kabushiki Kaisha, Shinagawa-ku (JP)

(21) Appl. No.: 11/401,136

(22) Filed: Apr. 10, 2006

(51) Int. Cl. H04N 1/40

(52) U.S. Cl. 358/448

(57) ABSTRACT

An image processing apparatus can generate reduced images such as a preview image and a thumbnail image, which are used for performing check of an image and selection of an image, with a small-sized circuit. The generation of the reduced image is performed substantially simultaneously with image reading. The image processing apparatus includes an image input unit, a first image processing unit that performs usual processing for the image data from the image input unit and outputs a first image processing result, a second image processing unit that performs reduction processing for the image data from the image input unit and outputs a second image processing result, a delay memory that temporarily stores the second image processing result that is the output of the second image processing unit, and an image output unit that connects the first image processing result from the first image processing unit and the second image processing result from the delay memory in time series and outputs the image processing results.

### BACKGROUND

1. Field

An embodiment of the present invention is suitably applied to an image reading apparatus that optically reads an original with a scanner and is suitably applied to a digital copying machine that forms an image on the basis of image data read by the image reading apparatus.

2. Description of the Related Art

Conventionally, for example, in order to check an image stored in a memory, a preview image and a thumbnail image are used. As a technique for generating a preview image and a thumbnail image, for example, there is a technique described in JP-A-2004-222246.

In paragraph 0084 of this document, it is mentioned that preview image generation processing for image check processing is performed after original reading processing ends once. When preview is performed during reading by a scanner, image data being read and a large quantity of image data such as image data for preview processing have to be processed simultaneously. This markedly deteriorates performance of an apparatus. Therefore, the preview image generation processing is performed after the original reading processing ends once.

However, when the preview image generation processing is performed after the original reading processing ends once, time when a user checks a preview image is delayed. The user desires to check the preview image at early time.

### BRIEF SUMMARY OF THE INVENTION

It is an object of an embodiment of the invention to allow an apparatus and a method for image processing to generate reduced images such as a preview image and a thumbnail image, which are used for performing check of an image and selection of an image, with a small-sized circuit and perform generation of the reduced images substantially simultaneously with image reading.

The apparatus and the method are effective for an image scanner that reads an image on paper and converts the image into an electronic file and an MFP (digital multi-function peripheral) that copies an image based on image data on paper and, at the same time, files the image data.

The embodiment includes: an image input unit; a first image processing unit that performs usual processing for the image data from the image input unit and outputs a first image processing result; a second image processing unit that performs reduction processing for the image data from the image input unit and outputs a second image processing result; a delay memory that temporarily stores the second image processing result that is the output of the second image processing unit; and an image output unit that connects the first image processing result from the first image processing unit and the second image processing result from the delay memory in time series and outputs the image processing results.

According to the embodiment, an image processing apparatus and an image processing method that are capable of performing generation of reduced images such as a thumbnail image and a preview image, which are required at the time of selection of an image and check of content, with a small-sized circuit at high speed simultaneously with usual image processing for scan and copying in the image scanner that reads paper information and converts the paper information into an electronic file and the MFP (digital multifunction peripheral) that copies an image on paper and, at the same time, files the image are realized. According to the means described above, when a reduced image is displayed during reading processing, it is possible to perform reduced image generation processing at high processing speed without decreasing processing speed of the reading processing.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a schematic constitution of a digital multi-function peripheral;

FIG. 2 is a diagram showing a constitution of a scanner image processing circuit that is an example of a scanner image processing circuit in FIG. 1 and simultaneously performs different kinds of image processing and outputs an image from one video I/F;

FIG. 3 is a timing chart for explaining an operation example of the scanning image processing circuit in FIG. 2;

FIG. 4 is a timing chart for explaining another operation example of the scanner image processing circuit in FIG. 2 and is a timing chart in the case in which different image processing results are connected and outputted in an identical page;

FIG. 5 is a timing chart for explaining still another operation example of the scanner image processing circuit in FIG. 2 and is a timing chart in the case in which different image processing results are outputted as different pages;

FIG. 6 is a diagram showing a constitution of a scanner image processing circuit that is another example of the scanner image processing circuit in FIG. 1 and outputs different image processing results to a video I/F and a host CPU I/F;

FIG. 7 is a timing chart for explaining an operation example of the scanner image processing circuit in FIG. 6;

FIG. 8 is an explanatory diagram showing a network scanner operation example for separating images connected on an identical line at the time of readout from an image memory;

FIG. 9 is an explanatory diagram showing a network scanner operation example for separating images connected on an identical line at the time of writing in an image memory; and

FIG. 10 is an explanatory diagram showing a network scanner operation example for reading out a thumbnail processing image with a host CPU.

### DETAILED DESCRIPTION OF THE INVENTION

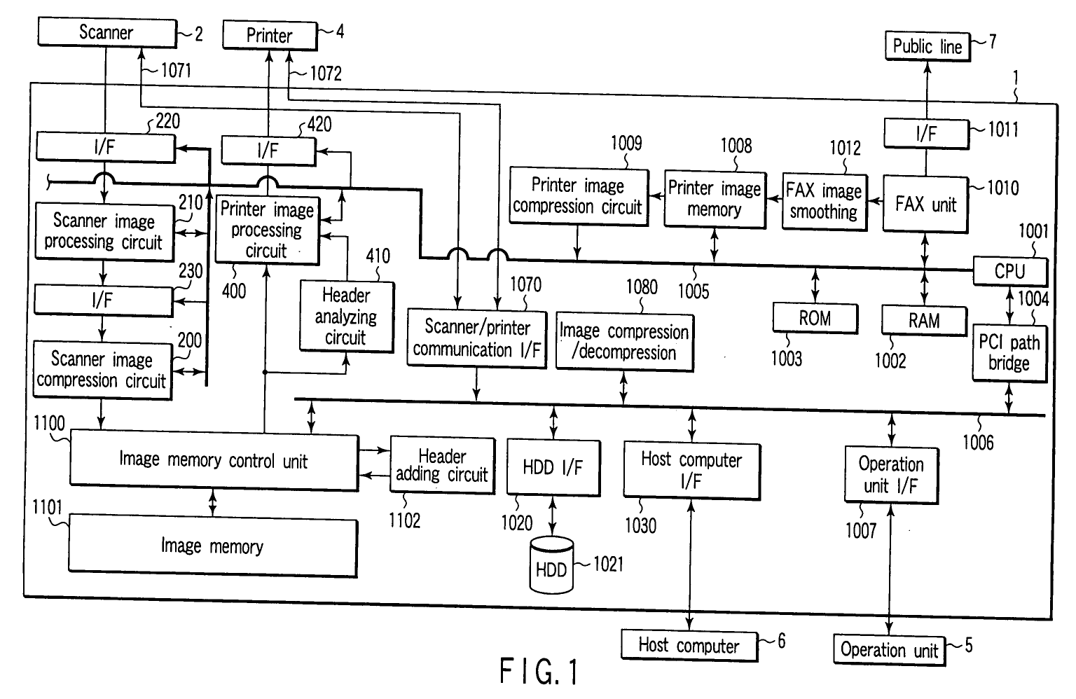

An image processing apparatus according to an embodiment of the invention will be hereinafter explained with reference to the drawings. FIG. 1 is an explanatory diagram for explaining an overview of an image processing apparatus 50 according to the invention.

<Explanation of the Entire Image Processing Apparatus 50>

The image processing apparatus 50 includes a system control unit 1, a scanner 2, a printer 4, and an operation unit 5. The scanner 2 has an image input unit that scans an original while radiating light on the original with a light source and reads an image of reflected light from the original with a color CCD sensor. The system control unit 1 performs operation control for the entire system. The scanner 2 scans the original while radiating light on the original with the light source and reads an image of the original. The printer 4 drives an LD (Laser Diode) according to image data, modulates an output, and prints or transfers and outputs an image on a paper surface. The operation unit 5 is a unit with which a user gives an instruction for operation setting to the apparatus. The operation unit 5 displays content and a state of setting in response to the instruction. The operation unit 5 has a graphical display that has a touch panel sensor, a ten key, a start key, a cancel key, a state display unit that uses LED, and the like.

The image processing apparatus 50 is used as an independent copying machine. Besides, it is possible to connect the image processing apparatus 50 to a host computer 6 via a host computer interface (I/F) 1030. It is also possible to connect the image processing apparatus 50 to a public line 7 using a FAX unit 1010 to perform FAX communication. It is also possible to transmit and receive an image as an electronic mail. Moreover, it is also possible to perform state monitoring, control, and the like for the apparatus from a remote location.

<Components and Functions of the System Control Unit 1>

Main components and functions of the system control unit 1 will be explained. The system control unit 1 has a Central Processing Unit (CPU) 1001 that controls respective functional blocks of the system.

The CPU 1001 controls the respective functional blocks via a local bus 1005 and collectively controls the entire system. A PCI bus 1006 is connected to a host bus of the CPU 1001 via a PCI bus bridge 1004. This makes it possible to perform data transfer between the CPU 1001 and devices on the CPU local bus 1005 and devices on the PCI bus 1006. Depending on a type of a CPU, a CPU host bus and a CPU local bus may be identical or a PCI bus bridge may be built in the CPU. By adopting the PCI bus 1006, it is possible to realize high-speed data transfer regardless of a type of a CPU and use existing devices complying with the PCI bus standard.

The CPU 1001 performs application processing for causing the image forming apparatus 50 to execute a copying function, a printer function, a scanner function, a facsimile function, an E-mail function, and the like necessary for the apparatus. The CPU 1001 controls data processing such as UI (User Interface) processing, communication control processing for communication with apparatuses connected locally or connected to a network, and image data format conversion and encoding processing for inputting and outputting image data.

The local bus 1005 is a bus for connecting a ROM 1003, a RAM 1002, and other peripheral devices to the CPU 1001. The RAM 1002 is used as a program memory and a data storage area for the CPU 1001 to execute processing. The ROM 1003 is used as a storage area for a boot program necessary for system start, programs for the CPU 1001 to realize the various functions, fixed data, and the like. The programs and the data stored in the ROM 1003 may also be held as compression data in the ROM 1003 or may be expanded on the RAM 1002 and used.

The CPU local bus 1005 is a bus for connecting the ROM 1003, the RAM 1002, and the other peripheral devices to the CPU 1001.

The FAX unit 1010 and a public line interface 1011 are modulation and demodulation devices for connecting the apparatus to the public line 7 such as PSTN or ISDN. This makes it possible to perform transmission and reception of facsimile, remote connection by a telephone line, and Internet connection by an ISP (Internet Service Provider).

FAX image data captured via the public line is subjected to image shaping processing to be shaped into a smooth image with printer printing resolution by a FAX image data smoothing circuit 1012 if resolution of the FAX image data is low compared with the printing resolution of a printer and captured into a printer image memory 1008. The image data in the printer image memory 1008 is subjected to compression processing for a data size in a printer image compression circuit 1009 such that storage of the image data in an HDD and transfer on the local bus 1005 and the PCI bus 1006 can be performed efficiently. The image data is stored in an HDD 1021. The image data compressed is read out from the HDD 1021 automatically or according to a printout instruction from the operation unit 5, subjected to decompression processing to be decompressed into the original printable image data by an image compression/decompression 1080, and expanded in an image memory 1101. The image data is subjected to image processing suitable to a type of an image such as a FAX, a copy, and a printer by a printer image processing unit 400, outputted to the printer 4, and printed.

Image data read by the scanner 2 is inputted to a scanner image processing circuit 210 via a scanner video I/F 220. Parameters necessary for image processing are set in the scanner image processing circuit 210 by the CPU 1001. The scanner image processing circuit 210 can also acquire attribute information (white and black, color, etc.) of the image data read. Moreover, the scanner image processing circuit 210 has an image processing unit that performs usual processing (scan processing and copying processing) such as γ correction, color conversion, main scanning magnification, image separation, finishing, area processing, and gradation correction processing. The scanner image processing circuit 210 can also perform generation of a reduced image other than the usual processing using the image data read by the scanner 2. The image data and the reduced image data outputted from the scanner image processing circuit 210 are inputted to a scanner image compression circuit 200 via a video I/F 230.

In the scanner image compression circuit 200, data compression according to encoding processing is performed by an image memory control unit 1100 as required. When image compression is unnecessary, no processing is performed in the scanner image compression circuit 200 and the image data is passed through the scanner image compression circuit 200. The image data subjected to data adjustment is temporarily stored in the image memory 1101.

The image data stored in the image memory 1101 may be compressed by the image compression/decompression circuit 1080 and, then, stored in the Hard Disk Drive (HDD) 1021. This makes it possible to perform electronic sort for outputting the temporarily stored image data in an arbitrary order by an arbitrary number of pieces of image formation. It is also possible to reconfigure plural documents as one document and print-output the document by temporarily storing plural print jobs and images read by the scanner 2 on the HDD 1021.

A hard disk drive I/F 1020 can control the HDD 1021 having IDE and SCSI in an I/F and perform data transfer to and from the RAM 1002 on the CPU local bus 1005 and the image memory 1101 on the PCI bus 1006 at high speed through the PCI bus 1006.

The image compression/decompression circuit 1080 encodes image data on the image memory 1101 or the RAM 1002 serving as a system memory to perform compression and decodes code data to perform decompression processing. As an encoding system, the image compression/decompression circuit 1080 copes with JPEG, MH/MR/MMR, JBIG, JBIG2, and the like, which are standard systems, and an encoding system corresponding to a processed image unique to the apparatus. In addition to the encoding and decoding functions, the image compression/decompression circuit 1080 has functions for conversion of a binary image and a multi-value image, conversion of monochrome and color, resolution conversion, and color space conversion and is capable of converting various image formats to one another.

The host computer I/F 1030 connects a PC (Personal Computer) and the like to the apparatus with a USB, a local connection I/F such as IEEE1284 or IEEE1394, or a network I/F such as an Ethernet.

By using a LAN (Local Area Network) such as the Ethernet for the host computer I/F 1030, it is possible to construct a more functional system that more flexibly connects plural MFPs, server PCs, client PCs, and the like and associates functions of the respective apparatuses. For example, an MFP can transfer image data read by the MFP to a server PC connected to the LAN and the server PC can apply OCR (character recognition) to an image sent to the server PC, integrate the image with the image data, and file the image in a storage in the server PC. The MFP stores the image read in an HDD in the MFP and the MFP itself functions as a file server or a WEB server. This allows a client PC connected to the LAN to directly access information in a main body of the MFP to retrieve a stored image and download the retrieved image to the client PC.

An operation unit I/F 1007 connects the operation unit 5 to the CPU 1001 through the PCI bus 1006. The operation unit 5 is a user I/F unit that has a graphical display mounted with a touch panel sensor, a ten key, a start key, a cancel key, a dedicated button frequently used, a state display unit that uses LED, and the like. A user can give an instruction for operation setting to the apparatus, check content of the operation setting on a display unit, and perform interactive operation with the apparatus using the operation unit 5.

The graphical display of the operation unit 5 can immediately display a reduced image of an image read. Consequently, the user is also capable of surely performing reading work for an image while checking whether the image read is read with a desired area, size, and image quality. It is also possible to use the graphical display in selecting image data stored. It is also possible to select the image data as a coarse image with a high reduction ratio and check image content according to detailed display.

The image memory control unit 1100 controls the large-capacity image memory 1101 capable of storing uncompressed image data and compressed encoded data of an image. The image memory control unit 1100 performs control for storing image data read by the scanner 2 in the image memory 1101 and control for reading out the image data stored in the image memory 1101 and performing print output of the image data with the printer 4.

The image memory control unit 1100 copes with handling of image data of various formats. For example, in a white and black format, the image memory control unit 1100 can perform processing for a binary image and a multi-value gray scale image. In a color format, the image memory control unit 1100 can perform uncompressed full color image processing, fixed length encoding processing in which an image is encoded and compressed in rectangular block units, and the like. Moreover, the image memory control unit 1100 has functions for input/output processing, rotation processing, processing for a rectangular area, and copy processing for a one-dimensional area concerning image data. The image memory control unit 1100 has functions for subjecting image data on the image memory 1101 to encoding processing and decoding processing by reversible variable length encoding and can also cope with various compression system.

A header adding circuit 1102 is connected to the image memory control unit 1100. The header adding circuit 1102 adds header information indicating attributes of an image to image data in which the image is blocked in unit rectangles. This header information is added when image data of various formats such as copy and print is expanded in the image memory 1101.

Since the block image data including the header is expanded in the image memory 1101 as data of a fixed size, it is possible to easily realize allocation in block units and rotation processing in 90 degree units in a state in which a two-dimensional page layout is maintained.

A header analyzing unit 410 specifies a type (a compression system, monochrome, color, etc.) of the block image data sent from the image memory 1101. The printer image processing unit 400 performs decompression processing and image processing for a compressed image on the basis of a result of judgment by the header analyzing unit 410, converts the image into a common image format necessary for the printer 4, and outputs the image to the printer 4 through a printer video I/F 420.

A scanner/printer communication I/F 1070 sends control information for a command and a status to the scanner 2 and the printer 4, respectively, according to serial communications 1071 and 1072. Consequently, it is possible to acquire the start and a state of the apparatus, a size and a type of an original read, designation of a sheet size, residual quantities of sheets and consumable stores, and the like.

As described above, since the system control unit 1 is connected to the scanner 2 and the printer 4, the system control unit 1 controls an operation of the scanner 2 to read color or white and black image data and controls the printer 4 to perform print output of the color or white and black image data. The system control unit 1 can temporarily store the image data read by the scanner 2 in the image memory 1101. Therefore, it is possible to repeatedly output a necessary number of pieces of images from the printer 4 by reading image data once. Moreover, the system control unit 1 makes it possible to perform, for example, N in 1 processing for reducing plural pages of images and arranging the images on one sheet, image rotation processing that makes it possible to perform arbitrary collation in 90 degree units, form combination processing for forming a document frame and the like in read image data, combination processing for a date, a logo, a watermark, and the like. By the image processing circuit 210, the image data read by the scanner 2 is simultaneously subjected to usual image processing such as scan processing and copying processing and reduced image processing at a high magnification for generating a thumbnail.

<A Unit for Forming Small Image Data and Reduced Image Data>

An image processing apparatus and an image processing method that are capable of performing generation of reduced images such as a thumbnail image and a preview image, which are required at the time of selection of an image and check of content, with a small-sized circuit at high speed simultaneously with usual image processing for scan and copying in the image scanner that reads paper information and converts the paper information into an electronic file and the MFP (digital multifunction peripheral) that copies an image on paper and, at the same time, files the image will be explained in detail. The usual image processing for scan and copying means non-reduction processing for not performing thumbnail and/or preview image processing.

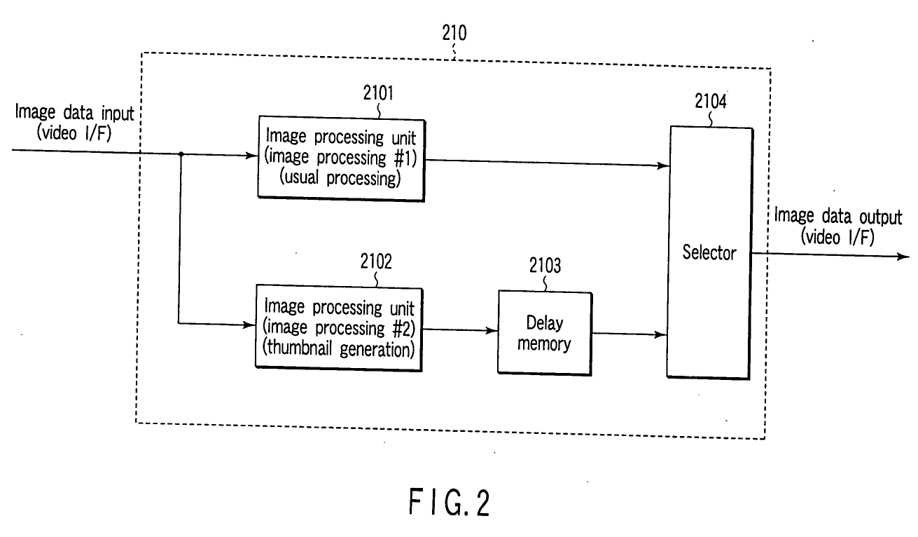

A schematic constitution of the scanner image processing circuit 210 that performs generation of reduced images such as a thumbnail image and a preview image simultaneously with image processing for scan and copying is shown in FIG. 2. The scanner image processing circuit 210 has an image processing unit 2101 and an image processing unit 2102, to which image data from the scanner 2 is simultaneously inputted, in parallel. The image processing unit 2101 performs usual image processing #1 for scanning and copying inputted image data. The image processing unit 2102 performs image processing #2 for reducing inputted image data at a high magnification in order to generate a reduced image (a thumbnail).

In the image processing #2 for performing high magnification reduction for input image data, since high magnification reduction is performed, strict calculation accuracy is unnecessary. In the image processing #2, it is possible to perform reduction processing at rough accuracy with a reduction magnification as low as a fraction that of an original image and at a fixed magnification or several stages of magnifications. Therefore, as the image processing #2, it is possible to realize simple thinning-out processing, averaging processing for the number of pixels calculated by multiplying the number of adjacent continuous pixels by each power of 2, and the like with an extremely simple and small-sized circuit and perform thumbnail generation processing at highest speed by processing an input on a real time basis.

Since reduced image data has a small data amount per one line, it is easy to store the reduced image data in an image processing circuit. Thus, it is possible to easily realize reduction processing in a sub-scanning direction of continuous plural input lines.

A processing result of the image processing #2 is inputted to one of selectors 2104 with timing of the input adjusted by a delay memory 2103. A selector 2104 selectively switches a processing result of the image processing #1 and a processing result of the image processing #2 to derive a processing result.

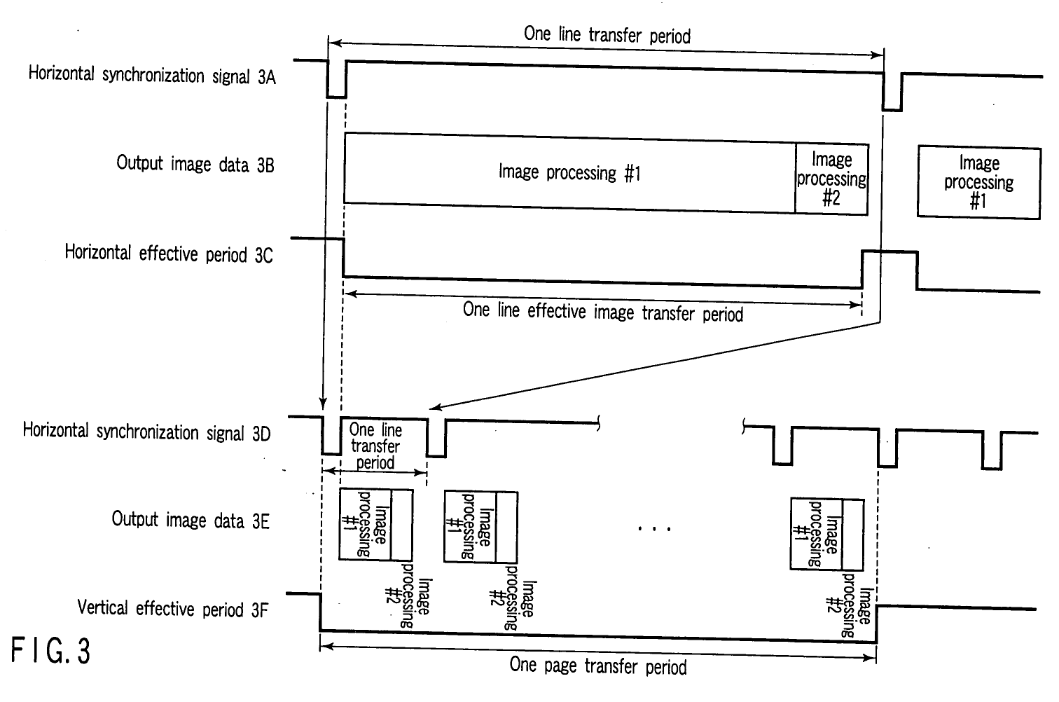

An embodiment in which image processing results of the image processing #1 and the image processing #2 are connected and outputted in one line period will be explained using FIG. 3. First, video transfer, which is an image transfer system adopted in the scanner image processing circuit 210, will be explained. In the scanner image processing circuit 210, as shown in FIG. 3, video I/F transfer for continuously transferring image data in line units in synchronization with a transfer clock (not shown) and transferring the image data by the number of lines in one page is performed. 3A is a horizontal synchronization signal, 3B is output image data from the selector 2104, 3C is a horizontal effective period signal, 3D is a horizontal synchronization signal, 3E is output image data from the selector 2104, and 3F is a vertical effective period signal (a one page transfer period).

The horizontal synchronization signal is a signal representing start of one line transfer. When the horizontal synchronization signal changes from a low level to a high level, data transfer for one line is started. The vertical effective period signal is a signal indicating that image data is effective over entire one page. When the signal is at a low level, the image data is effective. Image data for one line is transferred to be within a one line transfer period in synchronization with a transfer clock.

The horizontal effective period signal is a signal indicating that image data appearing in an output image data signal is effective. A reception side receives an image data signal as effective data when the vertical effective period signal is at the low level and the horizontal effective period signal is at the low level.

Connection and output of image processing results of the image processing #1 and the image processing #2 within one line period will be explained. First, a processing result of the image processing #1, which is the usual processing, is selected by the selector 2104 and outputted. After output of a processing result for one line of the image processing #1, a processing result for one line of the image processing #2 is selected by the selector 2104 and outputted.

An output result of the image processing #2 is held by the delay memory 2130 until the processing result for one line of the image processing #1 is outputted.

In this way, two image processing results processed simultaneously are connected using idle time of the one line transfer period and transferred as an image of one line. This makes it possible to use the conventional video I/F as it is and simultaneously transfer the two image processing results.

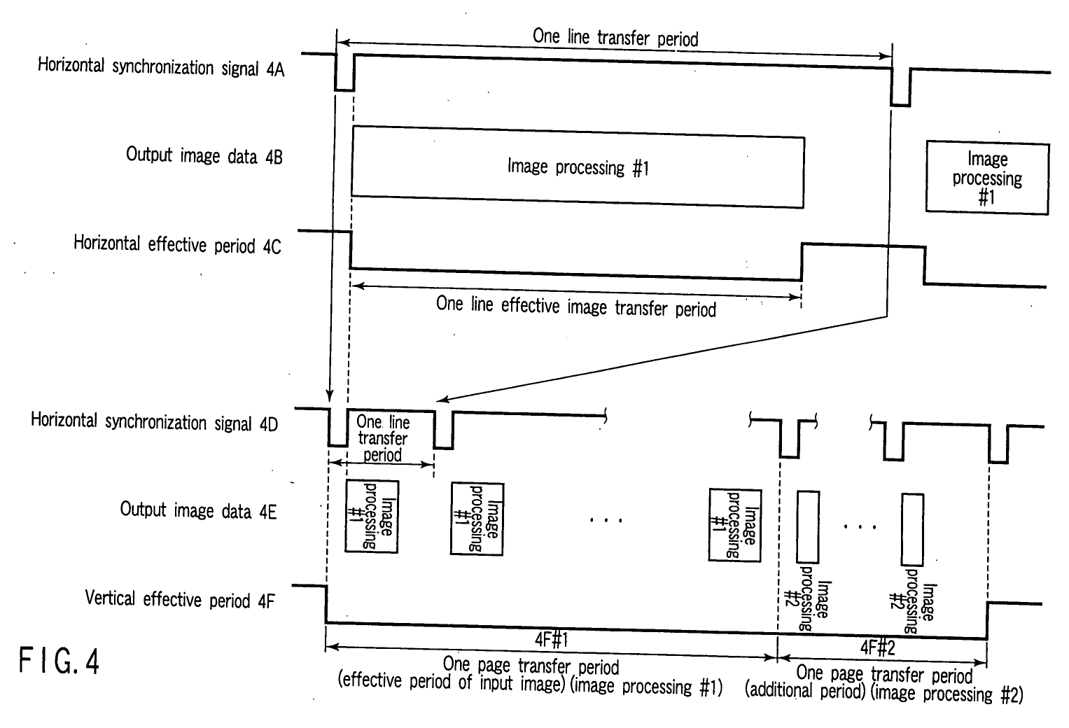

FIG. 4 shows another embodiment. In this embodiment, an example in which image processing results of the image processing #1 and the image processing #2 are connected and outputted in the one page transfer period will be explained.

It is assumed that the video transfer, which is the image transfer system adopted in the scanner image processing circuit 210, is the same operation as that shown in FIG. 3. 4A is a horizontal synchronization signal, 4B is an image processing result of the image processing #1, 4C is a horizontal effective period signal, 4D is a horizontal synchronization signal, 4E is output image data from the selector 2104, and 4F is a vertical effective period signal (a one page transfer period). An output of the delay memory 2103 is selected and a processing result of the image processing #2 is outputted in the latter half of the one page transfer period. Therefore, the selector 2104 selects and outputs an output of the image processing unit 2101 (a processing result of the image processing #1 that is the usual processing) in a period 4F#1 in the one page transfer period. An output result of the image processing #2 is held in the delay memory 2103 until a processing result for one page of the image processing #1 is outputted. In a period 4F#2, an output of the delay memory 2103 is selected and outputted. The vertical effective period signal is set such that one page transfer period is a period calculated by adding a page output period of the image processing #2 to an effective period of an input image.

In this way, since the transfer period 4F#2 for one page of a reduced image is added, it is possible to connect two image processing results, which are simultaneously processed, in page units and transfer the image processing results as an image of one page. This makes it possible to use the video I/F as it is and transfer the two image processing results.

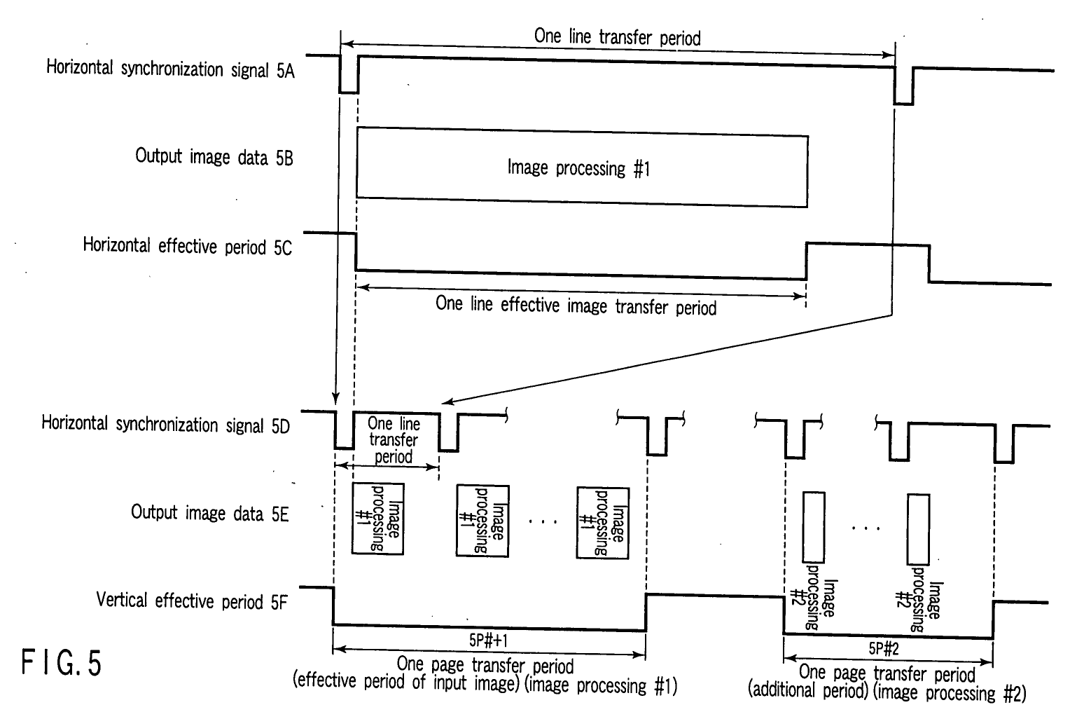

FIG. 5 shows a still another embodiment. This embodiment indicates an example in which image processing results of the image processing #1 and the image processing #2 are outputted as different pages, respectively. It is assumed that the video transfer, which is the image transfer system adopted in the scanner image processing circuit 210, is the same operation as that shown in FIG. 3. 5A is a horizontal synchronization signal, 5B is an image processing result of the image processing #1, 5C is a horizontal effective period signal, 5D is a horizontal synchronization signal, 5E is an output image data from the selector 2104, and 4F is a vertical effective period signal (a page transfer period).

Image processing results of the image processing #1 and the image processing #2 are outputted as different pages, respectively. In other words, when a vertical effective period signal 5P#1 corresponding to a vertical period of an input image is at a low level, a processing result of the image processing #1, which is the usual processing, is selected by the selector 2104 and outputted. The delay memory 2103 holds an output result of the image processing #2 until a processing result for one page of the image processing #1 is outputted.

The vertical effective period for one page of the input image is completed and the vertical effective period signal 5P#1 once returns to an inactive high level. Subsequently, a processing result for one page of the image processing #2 is selected by the selector 2104 and outputted. A vertical effective period signal 5P#2 outputted in this case is generated anew in order to output a processing result of the image processing #2 by an amount equivalent to one page.

In this way, since a one page transfer period is added in order to output the processing result of the image processing #2, it is possible to divide two image processing results, which are processed simultaneously, in page units as different pages and transfer the pages. This makes it possible to use the video I/F as it is and transfer the two image processing results.

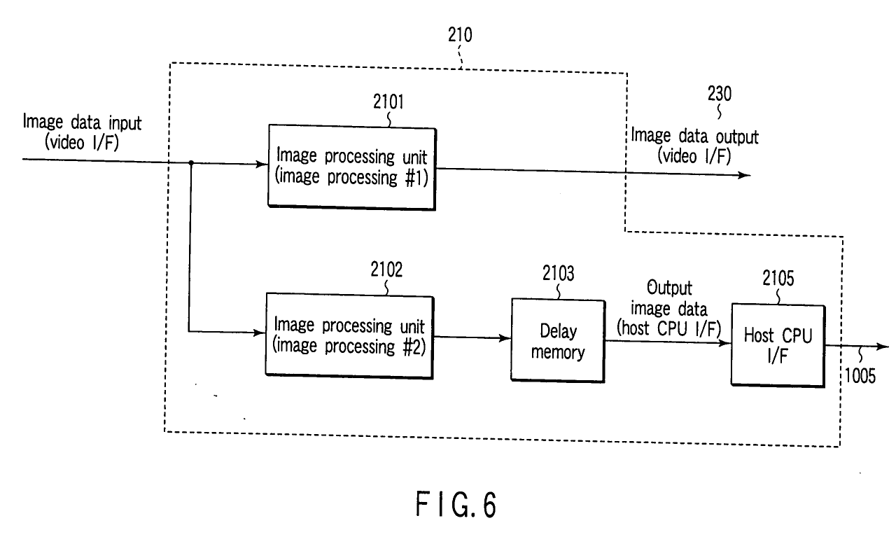

FIG. 6 shows another embodiment of the scanner image processing circuit 210 that performs generation of reduced images such as a thumbnail image and a preview image simultaneously with image processing for scan and copying.

The scanner image processing circuit 210 has an image processing unit 2101 that performs the usual image processing #1 for scan and copying and an image processing unit 2102 that performs reduced image processing #2 at a high magnification for thumbnail generation. Image data input from the scanner 2 is simultaneously inputted to both the image processing unit 2101 and the image processing unit 2102 and simultaneously processed in the image processing units.

In the image processing #2 for performing high magnification reduction for input image data, since high magnification reduction is performed, strict calculation accuracy is unnecessary. In the image processing #2, it is possible to perform reduction processing at rough accuracy with a reduction magnification as low as a fraction of that of an original image and at a fixed magnification or several stages of magnification. Therefore, as the image processing #2, it is possible to realize simple thinning-out processing, averaging processing for the number of pixels calculated by multiplying the number of adjacent continuous pixels by each power of 2, and the like with an extremely simple and small-sized circuit and perform thumbnail generation processing at highest speed by processing an input on a real time basis.

Since reduced image data has a small data amount per one line, it is easy to store the reduced image data in an image processing circuit. Thus, it is possible to easily realize reduction processing in a sub-scanning direction of continuous plural input lines.

Since a processing result of the image processing #2 is generated simultaneously with an image input (on a real time basis), the processing result is temporarily stored in the delay memory 2103. It is possible to lead data in the delay memory 2103 to the bus 1005 via the host CPU I/F 2105 under the control of the CPU 1001. In other words, the host CPU 1001 is capable of reading out the data in the delay memory 2103 in the scanner image processing circuit 210 via the host I/F 1005.

If the host CPU 1001 can read out the data in the delay memory 2103 simultaneously with the image processing #2 and readout speed is equivalent to processing speed of the image processing #2, the delay memory 2103 only has to have a capacity sufficient for relaxing timing. When readout speed of the host CPU 1001 is low or when it is desired to use a processing result for one page after the processing result is arranged, a delay memory having a capacity equivalent to one page of the processing result of the image processing #2 only has to be prepared or a delay memory having a capacity equivalent to several pages thereof only has to be prepared as required.

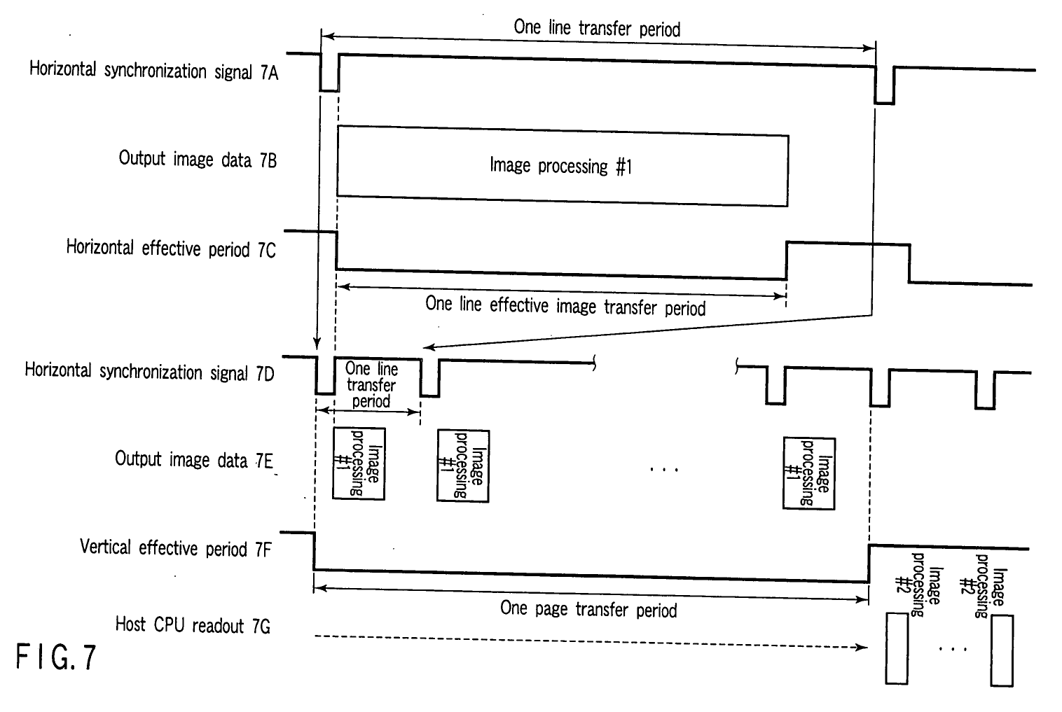

FIG. 7 is a timing chart showing an operation of the scanner image processing circuit 210 in FIG. 6. An embodiment in which the image processing #1 and the image processing #2 are simultaneously performed and processing results of the image processing #1 and the image processing #2 are outputted from different interfaces, respectively, will be explained.

It is assumed that the video transfer, which is the image transfer system adopted in the scanner image processing circuit 210, is the same operation as that shown in FIG. 3. 7A is a horizontal synchronization signal, 7B is an image processing result of the image processing #1, 7C is a horizontal effective period signal, 7D is a horizontal synchronization signal, and 7E is output image data as a processing result of the image processing #1 and indicates a state in which the output image data is extracted by an amount equivalent to one page via the video I/F 230. 7F indicates a vertical effective period in which the processing result of the image processing #1 is extracted. 7G indicates a state in which a processing result of the image processing #2 is extracted from the delay memory 2103 via the host CPU I/F 2105.

In this way, the image processing results of the image processing #1 and the image processing #2 are outputted from the different interfaces, respectively.

A processing result for one page of the image processing #1, which is the usual processing, is outputted to the video I/F in a vertical effective period of an input image. The image processing #2 proceeds simultaneously with the image processing #1 and a processing result of the image processing #2 is stored in the delay memory 2103.

When the vertical effective period for one page of the input image is completed, a vertical effective period signal temporarily returns to an inactive high level. Subsequently, the host CPU 1001 reads out the processing result for one page of the image processing #2, which is stored in the delay memory 2103, through the host I/F 2105.

In this embodiment, the host CPU 1001 reads out data in the delay memory 2103. However, another device serving as a transfer master may read out a processing result in the delay memory 2103 for itself and use the processing result.

For example, a graphical display controller may directly read out a reduced image on the delay memory 2103 and display the reduced image on the display.

Readout from the delay memory 2103 may be performed before a processing result for one page is stored. This makes it possible to extract a reduced image at time closer to time of a readout operation of the scanner and use the reduced image.

In this way, since the processing result of the image processing #2 is stored in the delay memory 2103 and read out from the host I/F, it is possible to further enlarge a range of use of the reduced image. In other words, since two image processing results processed simultaneously are read out from the different I/Fs, it is possible to transfer the two image processing results to many destinations.

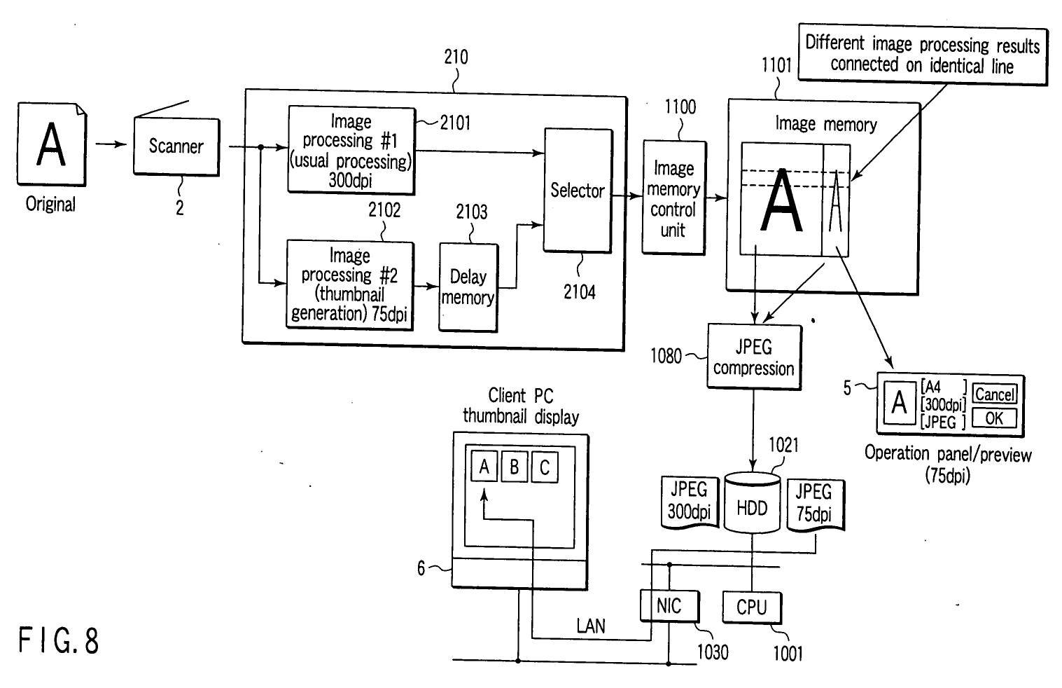

An example in which an embodiment of the invention is applied to a main body of an MFP will be described using FIG. 8. Blocks corresponding to those in FIG. 1 are denoted by reference numerals identical with those in FIG. 1. In this example, 300 dpi image data, which is a body of an image read by the scanner 2, is generated in the image processing #1. In the image processing #2, 75 dpi image data with low resolution is generated. The image data with low resolution is used as image data for preview on an operation panel of the operation unit 5 and used to be referred to as a thumbnail by the client PC 6.

As explained with reference to FIG. 3, the image processing #1 and the image processing #2 are simultaneously performed and image processing results of the image processing #1 and the image processing #2 are connected on identical one line and outputted from the selector 2104. Image data connected is received by the image memory control unit 1100 and two-dimensionally transferred to and arranged in the image memory 1101.

The 300 dpi image data, which is main data of the read image, is sliced at the time of readout from the image memory 1101, subjected to JPEG compression in the image compression/decompression circuit 1080, converted into a JPEG code, and stored in the HDD 1021.

The 75 dpi image data, which is a thumbnail image of the read image, is changed to an image reduced in both main scanning and sub-scanning by thinning out lines at the time of readout from the image memory 1101 (e.g., reading out one line every four lines). Since the thumbnail image read out is transferred to a display memory of the operation panel, it is possible to display the thumbnail image as a preview image.

The thumbnail image read out is subjected to JPEG compression in the image compression/decompression circuit 1080, converted into a JPEG code, and stored in the HDD 1021.

The MFP has a WEB server function and can form a command for a WEB browser using thumbnail image data stored in the HDD 1021. Since an image data size of a thumbnail image is extremely small compared with main scan data, it is possible to display the thumbnail image on the WEB browser at high speed.

In this example, the thumbnail image data is 75 dpi data and has resolution sufficient for checking document content in the client PC 6. Therefore, if a reduction ratio for display is decreased and a command on the WEB browser is generated to display the thumbnail image on a screen in a large size, it is also possible to use the thumbnail image data as preview.

A user of the client PC is allowed to select a target image file through rough image selection using a small thumbnail or content check by preview and give instructions for printing to a printer, management of a file, download of main scan image data to the client PC, and the like from the client PC.

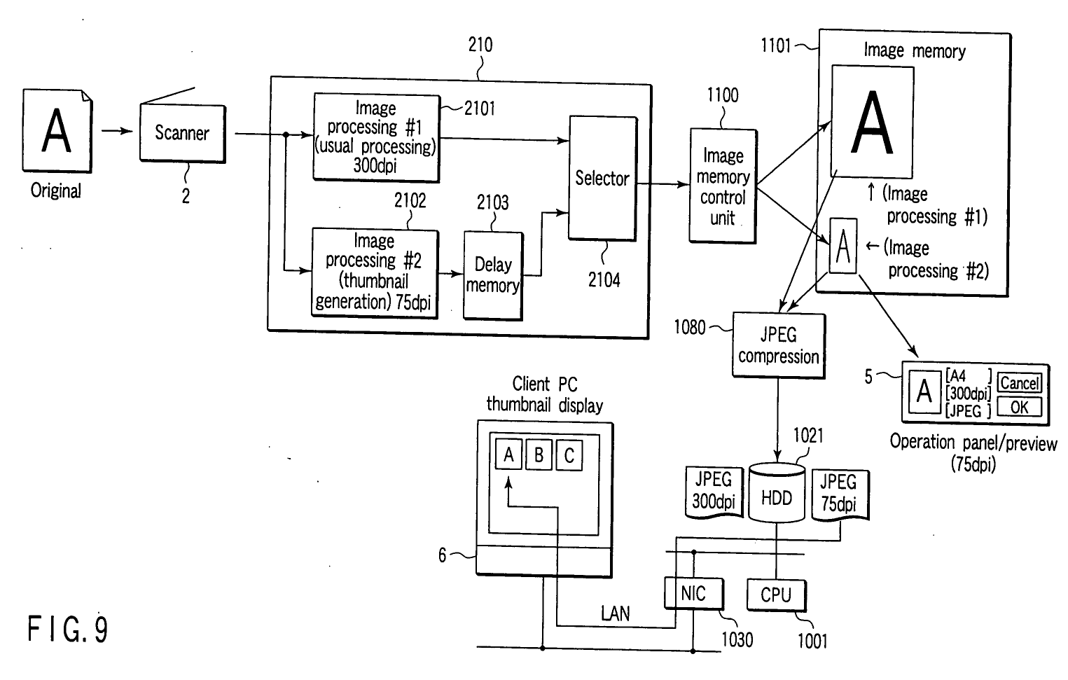

An example in which the embodiment of the invention is applied to a main body of an MFP will be described using FIG. 9. Blocks corresponding to those in FIG. 1 are denoted by reference numerals identical with those in FIG. 1.

In this example, if image data are connected on one line, the image memory control unit 1100 detects a boundary of processing results of the image processing #1 and the image processing #2 according to the number of image data in one line. The image memory control unit 1100 transfers the image data obtained by the image processing #1 and the image processing #2 to different areas of the image memory 1101, respectively, to be arranged two-dimensionally.

If image data are connected in page units in one page, the image memory control unit 1100 detects a boundary of processing results of the image processing #1 and the image processing #2 according to the number of lines of the image data forming one page. The image memory control unit 1100 transfers the image data obtained by the image processing #1 and the image processing #2 to different areas of the image memory 1101, respectively, to be arranged two-dimensionally.

If image data are divided into two pages and transferred, the image memory control unit 1100 detects a boundary of processing results of the image processing #1 and the image processing #2 according to a break of transfer of the respective pages. The image memory control unit 1100 transfers the image data by the image processing #1 and the image processing #2 to different areas of the image memory 1101, respectively, to be arranged two-dimensionally.

The 300 dpi main scan image data and the 75 dpi thumbnail image data expanded on a page memory, respectively, are previewed on the operation panel in the same manner and stored in the HDD 1021. It is possible to use the main scan image data and the thumbnail image data from the client PC 6.

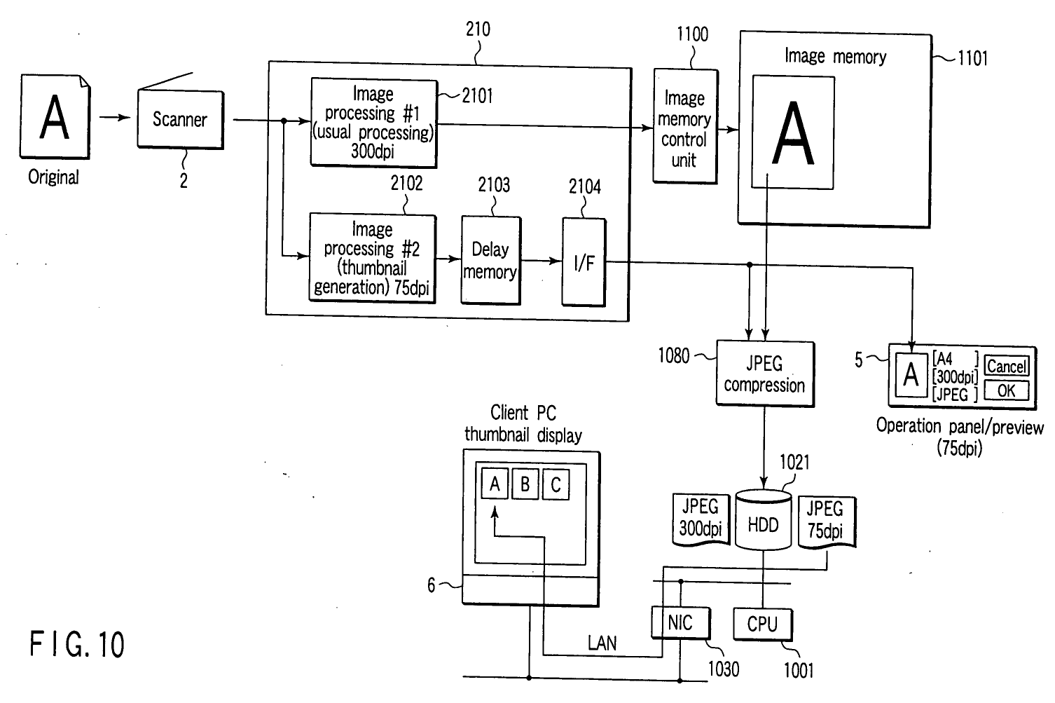

An example in which the embodiment of the invention is applied to a main body of an MFP will be described using FIG. 10. Blocks corresponding to those in FIG. 1 are denoted by reference numerals identical with those in FIG. 1.

In this example, the image memory control unit 1100 transfers main scan image data, which is a processing result of the image processing #1, to the image memory 1101 to be arranged two-dimensionally. The transfer of the main scan image data to the image memory 1101 and the image processing #2 proceed simultaneously and a processing result of the image processing #2 is stored in the delay memory 2103.

The 300 dpi image data, which is main scan image data of a read image, is sliced at the time of readout from the image memory 1101, subjected to JPEG compression in the image compression/decompression circuit 1080, converted into a JPEG code, and stored in the HDD 1021.

The host CPU 1001 can read out thumbnail image data on the delay memory 2105 generated by the image processing #2 and transfer the thumbnail image data to, for example, the display memory of the operation panel as a preview image. The thumbnail image data on the delay memory 2105 generated by the image processing #2 is subjected to JPEG compression in the image compression/decompression circuit 1080, converted into a JPEG code, and stored in the HDD 1021 by the host CPU.

It is possible to use the 75 dpi thumbnail image data and the 300 dpi main scan image data stored in the HDD from the client PC 6.

As described above, since simultaneous processing of image processing is used for generation of a reduced image, it is possible to generate a reduced image with an extremely high-speed and small-sized circuit without reading out large-volume original image data having a large processing load again using a storing device as in the past.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

In the embodiments described above, the reduced image processing is simultaneously performed in parallel with a copy operation and a scanner operation. However, an advantage of the invention is to make it possible to perform plural kinds of image processing simultaneously and transfer processing results in the same data transfer I/F as that in single processing and to make it possible to temporarily store the results simultaneously processed in a delay memory to read out the processing results at arbitrary timing. Therefore, it is needless to mention that the invention does not limit the number of kinds of image processing to be performed simultaneously and processing content.

What is claimed is:

1. An image processing apparatus comprising:
an image input unit;
a first image processing unit that processes the image data from the image input unit and outputs a first image processing result;
a second image processing unit that processes the image data from the image input unit and outputs a second image processing result;
a delay memory that temporarily stores the second image processing result that is the output of the second image processing unit; and
an image output unit that connects the first image processing result from the first image processing unit and the second image processing result from the delay memory in time series and outputs the image processing results.

2. An image processing apparatus according to claim 1, wherein the image output unit connects and outputs the first image processing result and the second image processing result from the delay memory in line units.

3. An image processing apparatus according to claim 1, wherein the image output unit connects and outputs the first image processing result and the second image processing result from the delay memory in page units.

4. An image processing apparatus according to claim 1, wherein the image output unit connects and outputs the first image processing result and the second image processing result from the delay memory in different pages.

5. An image processing apparatus according to claim 1, wherein the first image processing result and the second image processing result outputted from the image output unit are separated from an image memory and read out by an image memory control unit.

6. An image processing apparatus according to claim 1, wherein the first image processing result and the second image processing result outputted from the image output unit are separated and stored in different areas of an image memory by an image memory control unit.

7. An image processing apparatus according to claim 1 or 2 or 3 or 4 or 5 or 6, wherein the first image processing is usual processing and the second image processing is reduction processing.

8. An image processing apparatus according to claim 1, wherein
the first image processing result subjected to usual processing and outputted from the first image processing unit and the second image processing result subjected to reduction processing and outputted from the second image processing unit are stored in an image memory by an image memory control unit, and
the second image processing result in the image memory is transferred to a display memory of a display unit.

9. An image processing apparatus according to claim 1, wherein
the first image processing result subjected to usual processing and outputted from the first image processing unit and the second image processing result subjected to reduction processing and outputted from the second image processing unit are stored in an image memory by an image memory control unit, and
the second image processing result in the image memory is transferred to a display memory of an operation unit and displayed on an operation panel.

10. An image processing apparatus comprising:
an image input unit;
a first image processing unit that processes the image data from the image input unit and outputs a first image processing result;
a second image processing unit that processes the image data from the image input unit and outputs a second image processing result;
a delay memory that temporarily stores the second image processing result that is the output of the second image processing unit;
a first image output unit that outputs the first image processing result from the first image processing unit; and
a second image output unit that outputs the second image processing result from the delay memory.

11. An image processing apparatus according to claim 10, wherein the first image processing is usual processing and the second image processing is reduction processing.

12. An image processing apparatus according to claim 11, wherein
the second image output unit is independent from the first image output unit, and
the second image processing result is transferred to a display memory of a display unit.

13. An image processing apparatus according to claim 11, wherein
the second image output unit is independent from the first image output unit, and
the second image processing result is transferred to a display memory of an operation unit and displayed on an operation panel.

14. An image processing method that has an image input unit, a first image processing unit that outputs a first image processing result, a second image processing unit that outputs a second image processing result, and a delay memory and performs image processing, the image processing method comprising:
supplying image data from the image input unit in common to the first image processing unit and the second image processing unit;
obtaining the first image processing result according to usual processing by the first image processing unit;
obtaining the second image processing result, which is reduced image data, according to reduction processing by the second image processing unit;
temporarily storing the second image processing result in the delay memory;
outputting the first image processing result from the first image processing unit and the second image processing result from the delay memory; and
transferring the second image processing result from the delay memory to a display unit of an operation panel.
